(19) United States
(12) Patent Application Publication
(10) Pub. No.: US 2014/0310652 A1
(43) Pub. Date: Oct. 16, 2014

(54) INFORMATION PROCESSING APPARATUS,INFORMATION PROCESSING METHOD, AND NON-TRANSITORY COMPUTER READABLE MEDIUM

(71) Applicant: FUJI XEROX CO., LTD., Tokyo (JP)

(72) Inventor: Kazunaga HORIUCHI, Tokyo (JP)

(73) Assignee: FUJI XEROX CO., LTD., Tokyo (JP)

(21) Appl. No.: 14/140,174

(22) Filed: Dec. 24, 2013

(30) Foreign Application Priority Data
Apr. 12, 2013 (JP) 2013-083934

(51) Int. Cl. G06F 3/0482

(52) U.S. Cl. CPC G06F 3/0482
USPC 715/810

(57) ABSTRACT

An information processing apparatus includes a providing unit, a receiving unit, a presenting unit, and an output unit. The providing unit provides a service to a user. The receiving unit receives an operation performed by the user when using the service provided by the providing unit. The presenting unit presents options to the user using the service. The output unit outputs an option selected in the operation for selecting the option from among the options presented by the presenting unit when the receiving unit receives the operation. Specifically, the option is variably selected in accordance with an attribute of the user. When the providing unit provides the service, the providing unit outputs an image based on the option selected in the operation.

### CROSS-REFERENCE TO RELATED APPLICATIONS

This application is based on and claims priority under 35 USC 119 from Japanese Patent Application No. 2013-083934 filed Apr. 12, 2013.

### BACKGROUND

### Technical Field

The present invention relates to information processing apparatuses, information processing methods, and non-transitory computer readable media.

### SUMMARY

According to an aspect of the invention, there is provided an information processing apparatus including a providing unit, a receiving unit, a presenting unit, and an output unit. The providing unit provides a service to a user. The receiving unit receives an operation performed by the user when using the service provided by the providing unit. The presenting unit presents options to the user using the service. The output unit outputs an option selected in the operation for selecting the option from among the options presented by the presenting unit when the receiving unit receives the operation. Specifically, the option is variably selected in accordance with an attribute of the user. When the providing unit provides the service, the providing unit outputs an image based on the option selected in the operation.

### BRIEF DESCRIPTION OF THE DRAWINGS

Exemplary embodiments of the present invention will be described in detail based on the following figures, wherein:

FIG. 1 illustrates an example of a hardware configuration of an image forming apparatus;

FIG. 2 illustrates an example of a functional configuration realized by the image forming apparatus;

FIG. 3 illustrates an example of displayed usable images;

FIGS. 4A to 4F illustrate examples of decorative output images;

FIGS. 5A and 5B illustrate examples of images output for decoration;

FIG. 6 illustrates an example of options presented to a user;

FIG. 7 illustrates an example of a decoration table;

FIG. 8 is a flowchart illustrating an example of operation performed by the image forming apparatus during an acquisition process;

FIG. 9 illustrates an example of options presented to the user;

FIG. 10 illustrates another example of options presented to the user;

FIG. 11 illustrates an example of options presented to the user; and

FIG. 12 illustrates an example of operators presented as options.

### DETAILED DESCRIPTION

### 1. First Exemplary Embodiment

1.1. Hardware Configuration

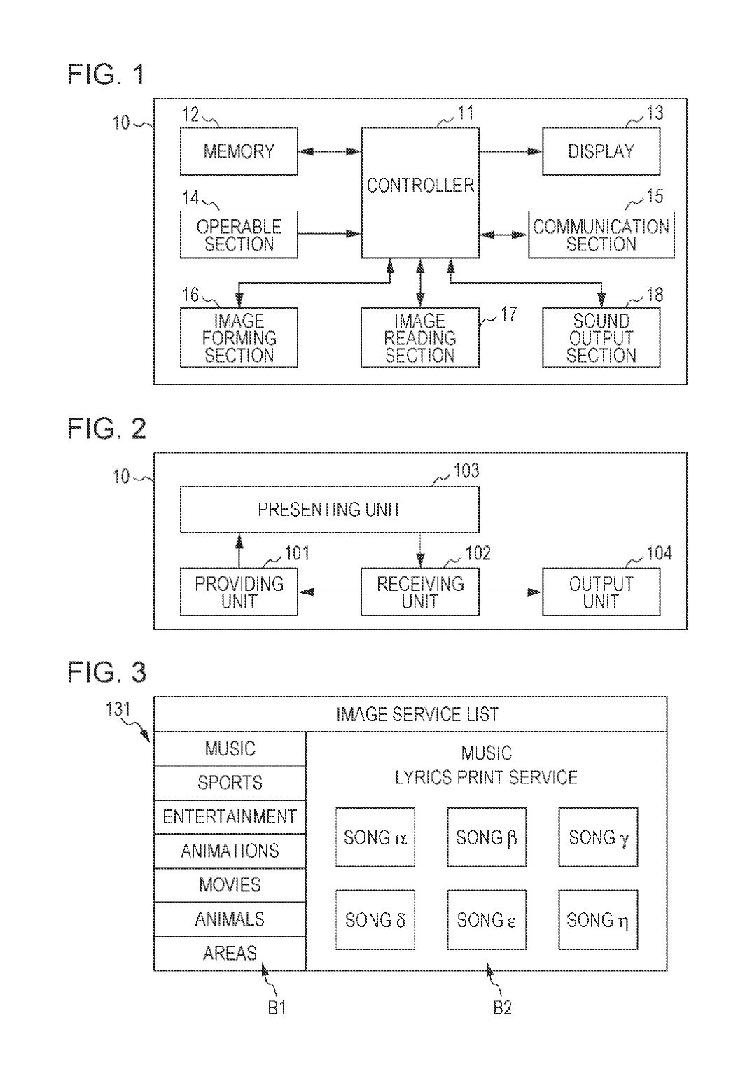

FIG. 1 illustrates an example of a hardware configuration of an image forming apparatus 10. The image forming apparatus 10 is configured to provide services for outputting images to users and to acquire information to be used for marketing (referred to as “marketing information” hereinafter). The term “marketing” refers to, for example, an activity for ascertaining what is desired by a user (so-called demand) and fulfilling such a demand so as to promote the sale of a product. The term “product” in this case includes not only an item that is used or eaten by a user, but also any kind of a service provided to a user, such as providing transportation to a user or providing a certain experience to a user. The marketing information includes not only information indicating user's demand, but also information used for presuming user's demand.

The image forming apparatus 10 is a computer that includes a controller 11, a memory 12, a display 13, an operable section 14, a communication section 15, an image forming section 16, an image reading section 17, and a sound output section 18. The controller 11 includes a central processing unit (CPU), a read only memory (ROM), a random access memory (RAM), and a real time clock. The CPU is configured to use the RAM as a work area and execute a program stored in the ROM or the memory 12 so as to control the operation of each section. The real time clock calculates the current time and notifies the CPU of the calculated time.

The memory 12 includes, for example, a flash memory or a hard disk and is configured to store, for example, data and programs to be used for control by the controller 11, as well as image data. The display 13 includes, for example, a liquid crystal display and is configured to display an image on a display screen. The operable section 14 includes operators, such as buttons or a touch-screen overlying the display screen, and is configured to receive an operation performed by the user. Operational data according to user's operation received by the operable section 14 is supplied to the controller 11 so that the controller 11 performs processing in accordance with this operational data.

The communication section 15 includes a communication circuit for performing communication and is configured to communicate with an external device. The communication section 15 supplies data received via the communication to the controller 11. The image forming section 16 is configured to form an image onto a medium, such as paper, based on, for example, an electrophotographic method by using yellow (Y), magenta (M), cyan (C), and black (K) toners. For example, when a facsimile function or an image forming function is executed, the image forming section 16 forms an image indicated by image data onto a recording medium so as to output the image data to the medium. The image reading section 17 is configured to optically read the image formed on the medium, such as paper. The image reading section 17 supplies the image data indicating the read image to the controller 11. The sound output section 18 includes, for example, a speaker and a sound processing circuit and is configured to output sound from the speaker under the control of the controller 11.

1.2. Functional Configuration

Based on the above hardware configuration, the image forming apparatus 10 performs an acquisition process for acquiring marketing information. The memory 12 stores a program for executing the acquisition process. The controller 11 executes this program and controls each section so as to realize the following functions.

FIG. 2 illustrates an example of a functional configuration realized by the image forming apparatus 10. The image forming apparatus 10 includes a providing unit 101, a receiving unit 102, a presenting unit 103, and an output unit 104. With regard to the following description of these units, the providing unit 101 will be described in two separate parts (referred to as “Part 1” and “Part 2” for the sake of convenience).

1.2.1. Providing Unit 101 (Part 1)

For example, the providing unit 101 is configured to provide a service to a user. The term “user” in this case refers to a person using the apparatus. The service provided by the providing unit 101 includes, for example, a print service for outputting an image indicated by image data stored in, for example, a smartphone to a medium, a copy service for outputting an image on, for example, paper to a medium, a scan service for reading the image so as to generate image data, and a facsimile service for performing a facsimile transmission process. In addition, the providing unit 101 also provides a service for outputting an image that indicates contents, such as information about a surrounding area, information about a movie, information about learning, and information about sports (such a service will be referred to as “contents service” hereinafter). A group of services provided by the providing unit 101 by outputting and reading images in this manner will be referred to as “image service” hereinafter. The image service is an example of “service” according to an exemplary embodiment of the present invention.

The providing unit 101 is a function that is realized by the controller 11, the display 13, the communication section 15, the image forming section 16, and the image reading section 17. For example, in the print service, image data transmitted from an external device, such as a smartphone, is supplied to the controller 11 via the communication section 15, and the controller 11 controls the image forming section 16 so as to cause the image forming section 16 to output an image indicated by the image data to a medium. In the scan service, image data of an image read by the image reading section 17 is supplied to the controller 11, and the controller 11 causes the display 13 to display the image data and then, for example, transmits the image data to a destination designated by the user via the communication section 15. In the contents service, for example, the controller 11 controls the image forming section 16 so as to cause the image forming section 16 to output a content stored in advance in the memory 12 to a medium.

1.2.2. Receiving Unit 102

For example, the receiving unit 102 is configured to receive an operation performed by the user when the user desires to use a service provided by the providing unit 101. The receiving unit 102 is a function realized by, for example, the controller 11, the memory 12, the display 13, and the operable section 14. The memory 12 stores images (referred to as “usable images” hereinafter) to be displayed when the image service is used, and the controller 11 causes the display 13 to display these usable images.

FIG. 3 illustrates an example of displayed usable images. In this example, usable image groups B1 and B2 are displayed on a display screen 131 of the display 13. The usable image group B1 indicates image-service categories (i.e., “music”, “sports”, “entertainment”, etc.), and the usable image group B2 indicates contents (i.e., “song α”, “song β”, “song γ”, etc.) provided by a so-called lyrics print service (which is an image service that outputs the lyrics of a song to a medium) in this example. For example, when the user taps a position where “song α” is displayed, operational data indicating that this position has been tapped is supplied to the controller 11. Based on the positions of the displayed usable images and the position indicated by the supplied operational data, the controller 11 receives a selection operation in which “song α” has selected. The receiving unit 102 receives this operation and notifies the providing unit 101 and the output unit 104 of the detail of the received operation.

1.2.3. Presenting Unit 103

For example, the presenting unit 103 is configured to present options to the user using the service (i.e., the image service in this exemplary embodiment). The presenting unit 103 is a function realized by, for example, the controller 11, the memory 12, and the display 13. In the image service, the presenting unit 103 presents, for example, the following options to the user. For example, in the case of the print service, the presenting unit 103 presents options for the size of the medium (such as sizes A4, A5, B4, and B5) so as to allow the user to select a medium onto which an image is to be output. In the case of the scan service, the presenting unit 103 presents options for the resolution (such as 200 dots per inch (dpi), 400 dpi, and 600 dpi) used for reading an image.

In addition to the above, the presenting unit 103 presents options related to the details of decoration to be performed in the service. The term “decoration” in this case refers to, for example, outputting a frame image, a background image, an image symbolizing a certain subject, a character image, and the like in addition to the image that the user desires to output in the case of the print service. These images to be output for the decoration will be referred to as “decorative output images” hereinafter. In the case of the scan service, for example, the decoration involves displaying an image, such as a still image or a moving image, on the display 13 during the scanning process, or outputting sound, such as music or sound effect, from the sound output section 18. These images to be displayed for the decoration will be referred to as “decorative display images” hereafter, and the sound to be output will be referred to as “decorative output sound” hereinafter.

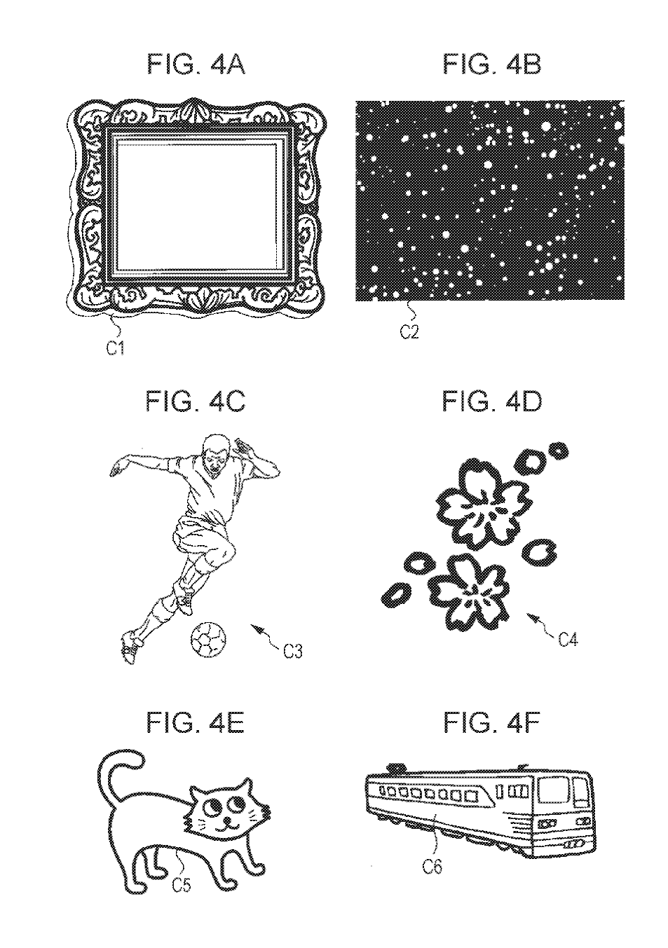

FIGS. 4A to 4F illustrate examples of the decorative output images. Specifically, FIG. 4A illustrates a decorative output image C1 expressing a frame. FIG. 4B illustrates a decorative output image C2 expressing a snowing background. FIGS. 4C and 4D illustrate decorative output images C3 and C4 which are images symbolizing soccer and cherry blossoms (referred to as “symbolic images” hereinafter), respectively. FIG. 4E illustrates a decorative output image C5 which is an image expressing a cat character (referred to as “character image” hereinafter). FIG. 4F illustrates a decorative output image C6 which is an image expressing the external appearance of a train (referred to as “external-appearance image” hereinafter). These decorative output images are stored in the memory 12.

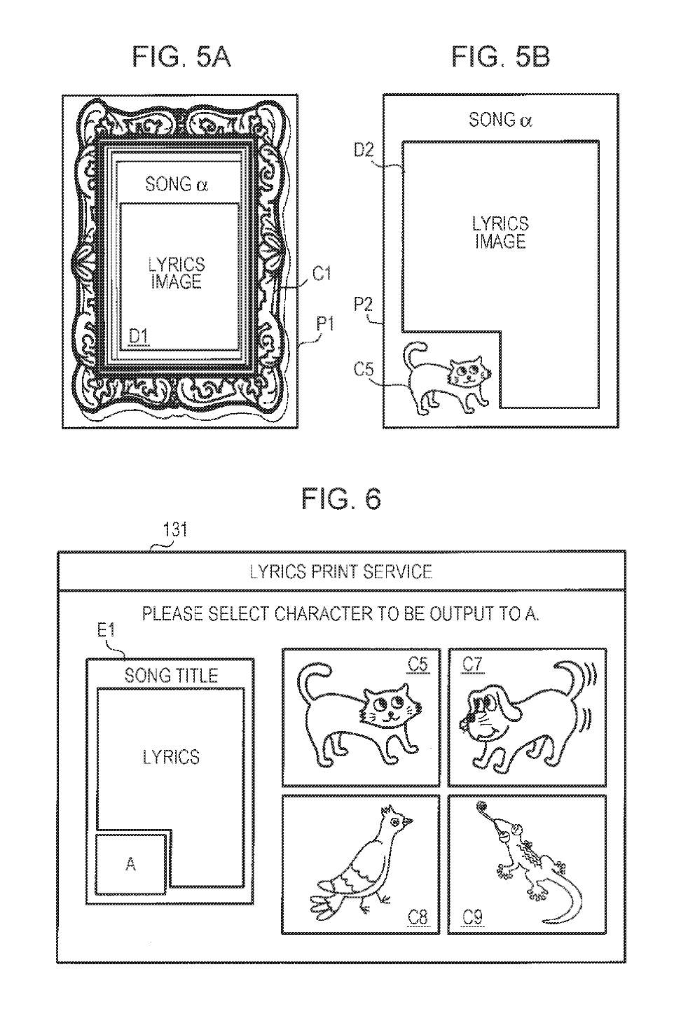

FIGS. 5A and 5B illustrate examples of images output for the decoration. Specifically, FIGS. 5A and 5B illustrate media P1 and P2 to which images D1 and D2 (referred to as “lyrics images” hereinafter) expressing the lyrics of the song α are output, respectively. The decoration performed in the example shown in FIG. 5A involves surrounding the lyrics image D1 with the frame expressed by the decorative output image C1 shown in FIG. 4A. This decoration gives a luxurious impression to the overall image. The decoration performed in the example shown in FIG. 5B involves setting the decorative output image C5 (i.e., the cat character) in a recessed area of the lyrics image D2. This decoration gives a joyful impression to the overall image.

Accordingly, by performing decoration in the image service, an impression according to the decoration detail is given to the user. In other words, decoration (such as outputting an image or outputting sound) is performed for giving some kind of impression to the user. The presenting unit 103 presents to the user, for example, options from which a decorative output image is selectable, as options related to decoration details.

FIG. 6 illustrates an example of options presented to the user. In this example, images displayed on the display screen 131 are shown after a song (e.g., song α) whose lyrics are to be output has been selected from the usable image group B2 shown in FIG. 3 in the aforementioned lyrics print service. The display screen 131 displays a sample E1 expressing the external appearance of an image to be output when the decoration shown in FIG. 5B is performed, as well as decorative output images C5, C7, C8 and C9 as selectable options for an image to be output to an area A within the sample E1. These decorative output images C5, C7, C8 and C9 express a cat character, a dog character, a bird character, and a reptile character, respectively.

The controller 11 reads the decorative output images C5, C7, C8 and C9 from the decorative output images stored in the memory 12 and causes the display 13 to display the decorative output images C5, C7, C8 and C9, so that the presenting unit 103 presents the options shown in FIG. 6 to the user. The presenting unit 103 displays a character string “Please select character to be output to A” so as to inform the user that the presented decorative output images are selectable options. When the user taps, for example, the decorative output image C5, the controller 11 outputs the image shown in FIG. 5B (i.e., the image including the lyrics image D2 and the decorative output image C5) to a medium so that decoration is performed in accordance with the detail selected by the user, thereby providing the lyrics print service.

In the example shown in FIG. 6, the image service is not provided unless any of the decoration details is selected. Alternatively, an option for not performing decoration may be presented. In that case, the user does not have to select any kind of decoration if there are no presented decoration details desired by the user, and is still capable of receiving the provided image service.

1.2.4. Output Unit 104

For example, among the options presented by the presenting unit 103, when an option selecting operation that varies depending on user's attribute is received by the receiving unit 102, the output unit 104 is configured to output the option selected in that operation. The output unit 104 is a function realized by, for example, the controller 11 and the communication section 15.

The term “user's attribute” refers to, for example, user's physical characteristics, such as age and sex, user's living environment, such as current address and family structure, user's skill, such as occupation and professional skill, user's interest, such as hobby and collection, a field of products that the user is interested in, and user's future activity plan. For example, in the case of the lyrics print service shown in FIG. 3, the lyrics for “song α”, which is a blues song, “song β”, which is a pop song, “song γ”, which is a rock song, “song δ”, which is a rap song, “song ε”, which is a children's song, and “song η”, which is a war song, are provided. In this case, the selection of one of these options varies depending on the attribute indicating user's interest corresponding to “favored music”.

In this exemplary embodiment, the output unit 104 outputs the decoration detail selected in accordance with the operation received by the receiving unit 102. For example, when the options shown in FIG. 6 are presented, since these options all correspond to character images of animals, a joyful impression is given to the overall image regardless of any selection of these options. If the user has an attribute in which the user likes cats, the user is likely to select the decorative output image C5 as compared with the other options due to a psychological effect on the user wanting to see the cat character image. Likewise, if the user has an attribute in which the user likes dogs, birds, or reptiles, the user is likely to select the decorative output image C7, C8, or C9 as compared with the other options.

Specifically, the decorative output images C5, C7, C8, and C9 express decoration details and are options that are variably selected in accordance with user's attribute. When the user selects, for example, the decorative output image C5 from these options, the output unit 104 outputs the selected decorative output image C5 expressing the decoration detail. The output unit 104 outputs the decorative output image C5 to, for example, an external device, which is an access destination stored in advance in the memory 12. This external device is a device used by a distributor who utilizes the marketing information acquired by the image forming apparatus 10 to promote the sale of a product.

The output destination of the selected option is not limited to the above. For example, the output unit 104 may output the selected option to an electronic mail address of the distributor. Alternatively, the output unit 104 may output the selected option to the display 13, and the distributor may view the displayed option. As another alternative, the output unit 104 may output the selected option to the memory 12 where the selected option is stored, and the distributor may refer to the selected option via, for example, a network.

Instead of outputting the decorative output image, the output unit 104 may output, for example, a character string or a symbol that expresses the decoration detail expressed by the decorative output image. In that case, the output unit 104 stores a decoration table in which decorative output images and decoration details are set in correspondence with each other.

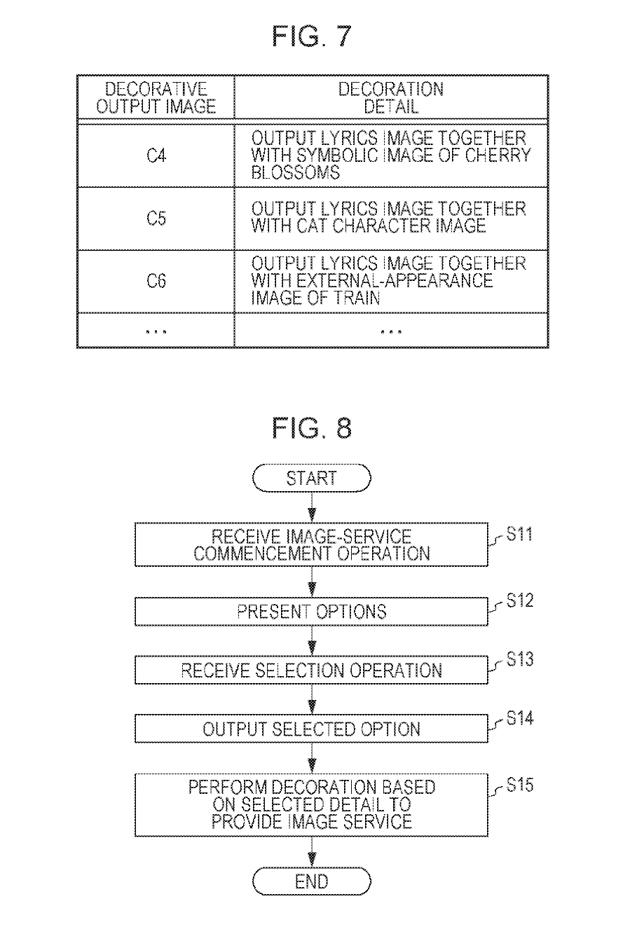

FIG. 7 illustrates an example of the decoration table. In this example, the decorative output image C4 is set in correspondence with the decoration detail “output lyrics image together with symbolic image of cherry blossoms”, the decorative output image C5 is set in correspondence with the decoration detail “output lyrics image together with cat character image”, and the decorative output image C6 is set in correspondence with the decoration detail “output lyrics image together with external-appearance image of train”. The output unit 104 outputs the character string indicating the decoration detail set in correspondence with the selected decorative output image in the decoration table to the external device. Since the output character string expresses the decoration detail and also indicates the option selected by the user, the output unit 104 outputs the decoration detail selected by the user as the option selected by the user.

1.2.5. Providing Unit 101 (Part 2)

When providing the aforementioned image service, if the receiving unit 102 receives an operation for selecting an option, the providing unit 101 outputs an image based on the option selected in that operation. The image based on the selected option includes the lyrics image and the decorative output image shown in FIG. 5A or 5B. In other words, the providing unit 101 provides the image service by providing the image based on the selected option.

1.3. Operation

The image forming apparatus 10 performs the aforementioned acquisition process based on the above-described configuration. The operation performed by the image forming apparatus 10 in the acquisition process will be described below.

FIG. 8 is a flowchart illustrating an example of the operation performed by the image forming apparatus 10 during the acquisition process. The acquisition process commences when the user performs an operation for commencing the image service (referred to as “image-service commencement operation” hereinafter).

First, in step S11, the image forming apparatus 10 receives the image-service commencement operation performed by the user. Specifically, step S11 is performed by the receiving unit 102. Then, in step S12, for example, when the usable image group B2 shown in FIG. 3 is displayed and a song is selected, the image forming apparatus 10 presents options expressing the decoration details shown in FIG. 6. Specifically, step S12 is performed by the presenting unit 103. In step S13, when the user performs an operation for selecting any one of the options (referred to as “selection operation” hereinafter), the image forming apparatus 10 receives the selection operation.

In step S14, the image forming apparatus 10 outputs the option selected in the selection operation received in step S13. In this exemplary embodiment, the image forming apparatus 10 outputs the option expressing the decoration detail to an external device. Specifically, step S14 is performed by the output unit 104. In step S15, the image forming apparatus 10 performs decoration based on the selected detail so as to provide the image service. In detail, when the decorative output image C5 shown in FIG. 6 is selected in step S13, the image forming apparatus 10 outputs the decorative output image C5 together with the lyrics image D2 shown in FIG. 5B as an image based on the option selected by user's operation. Specifically, step S15 is performed by the providing unit 101.

In this exemplary embodiment, for example, when the decorative output image C5, which is a cat character image, is selected from the options shown in FIG. 6, it is presumed that the user has an attribute in which the user likes cats. In other words, the option selected by the user expresses user's attribute better than the unselected options. When user's attribute is confirmed, the demand of that user is presumed. For example, if a user has an attribute in which the user likes cats but does not own a cat, it is presumed that there is a demand by the user that the user may desire to own a cat. If the user already owns a cat, it is presumed that there is a demand for cat food and cat-related goods. These presumed demands are utilized for marketing.

Accordingly, the option selected by the user in this exemplary embodiment, that is, an option that is variably selected in accordance with user's attribute, may be utilized as marketing information.

On the other hand, the user simply performs the operation for selecting the decoration detail of the image service and does not have to answer any questions in the form of a questionnaire survey. Thus, it is unlikely that the user may feel that the operation performed by the user is utilized for marketing information, as compared with a case where the user answers such questions. According to this exemplary embodiment, marketing information may be acquired without the user being aware of it.

In this exemplary embodiment, since the decoration detail is selected by the user, the impression given to the user by the decoration tends to be that desired by the user, as compared with a case where, for example, decoration is performed based on a predetermined detail. According to this exemplary embodiment, when the user uses the service, marketing information may be acquired while giving the user an impression desired by the user.

For example, in a case where the image forming apparatus 10 is installed in a service facility, such as a rest area of an expressway, it may be determined what kind of demands there are based on the season, time frame, and place or which product, etc. is desired by a user by acquiring the aforementioned marketing information. By selling a product, for example, based on the determination result, the satisfaction level of the user improves. As a result, the number of visitors visiting the service facility increases, thus contributing to improved sales for the retail stores in the service facility.

### 2. Second Exemplary Embodiment

A second exemplary embodiment of the present invention will be described below while focusing on the differences from the first exemplary embodiment. Although options related to the details of decoration performed in the service are presented to the user in the first exemplary embodiment, the details of contents provided by the service are presented as options in the second exemplary embodiment.

2.1. Functional Configuration

In this exemplary embodiment, the presenting unit 103 presents the details of contents provided by the service as options. The contents provided by the service include the following two kinds of contents. The first kind includes contents provided in the aforementioned contents service. This will be referred to as “first contents” hereinafter. The second kind is not related to the provided service and includes contents provided, for example, by a provider of a location where the image forming apparatus 10 is installed (referred to as “installation location” hereinafter) or by an image-service provider. This will be referred to as “second contents” hereinafter. The second contents include, for example, a tourist map of an area surrounding the installation location and a tourist-site pamphlet.

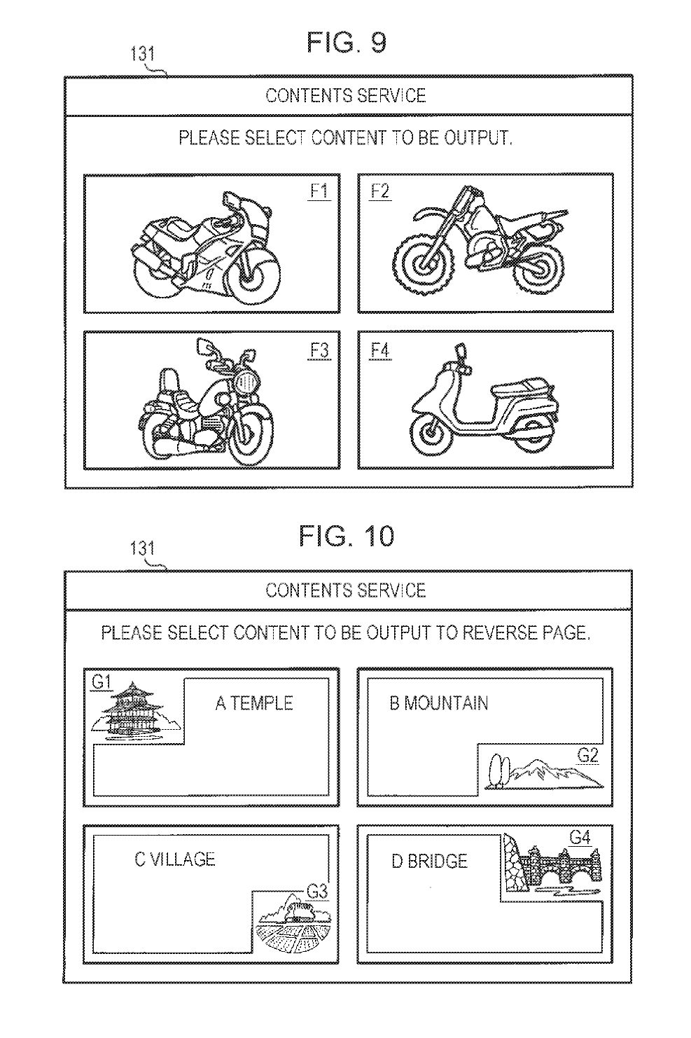

FIG. 9 illustrates an example of options presented to the user. In this example, the details of the first contents provided in the contents service are displayed as options on the display screen 131. The display screen 131 displays external-appearance images F1, F2, F3, and F4 that express the external appearances of a racer replica motorcycle, an off-road motorcycle, an American style motorcycle, and a scooter, respectively. These external-appearance images express the details of the first contents.

When the options shown in FIG. 9 are presented, if the user has an attribute in which the user likes racer replica motorcycles, the user is likely to select the external-appearance image F1 as compared with the other options due to a psychological effect on the user wanting to see the external-appearance image of the racer replica motorcycle. Likewise, if the user has an attribute in which the user likes off-road motorcycles, American style motorcycles, or scooters, the user is likely to select the external-appearance images F2, F3, or F4 as compared with the other options. Specifically, the external-appearance images F1, F2, F3, and F4 express the details of the contents provided in the contents service and are options that are variably selected in accordance with user's attribute. Therefore, the detail of the first content selected by the user in the example in FIG. 9 may be utilized as marketing information.

The output unit 104 outputs the detail of the content (i.e., any one of the external-appearance images F1, F2, F3, and F4 in the example in FIG. 9) selected in the operation received by the receiving unit 102. Thus, the aforementioned distributor may utilize the output content as marketing information so as to promote the sale of a product. The output unit 104 is not limited to a type that directly outputs the external-appearance image expressing the detail of the selected content. The output unit 104 may output, for example, a character string or a symbol so long as it expresses the detail of the selected content. In that case, the output unit 104 uses a table in which the external-appearance images serving as options and the character strings or symbols expressing the details of the contents are set in correspondence with each other, as in, for example, the table shown in FIG. 7. Because the output character string or symbol expresses the selected content and also expresses the option selected by the user, the output unit 104 outputs the detail of the content selected by the user as an option selected by the user.

FIG. 10 illustrates another example of options presented to the user. In this example, tourist-site pamphlets, which are examples of the aforementioned second contents, are displayed as options on the display screen 131. The display screen 131 displays second contents G1, G2, G3, and G4 expressing pamphlets for “A Temple”, “B Mountain”, “C Village”, and “D Bridge”, respectively, which are tourist sites located in the vicinity of the installation location of the image forming apparatus 10. The display screen 131 also displays a character string “Please select content to be output to reverse page”. Thus, the user is informed that a second content that is different from the content to be output to the front page will be output.

For example, in a case where the installation location of the image forming apparatus 10 is in a rest area of an expressway, it is desirable that pamphlets for tourist sites located in the vicinity of the next exit of the expressway after the rest area be set as options. Thus, if a tourist site that the user is planning to visit is included, it is likely that the pamphlet for that tourist site may be selected as compared with the other pamphlets. Even if that tourist site is not included, it is likely that a pamphlet for a tourist site that the user is most interested in may be selected as compared with the other pamphlets. In other words, the second contents shown in FIG. 10 are options that are variably selected in accordance with user's attribute corresponding to user's planned activity or user's attribute corresponding to a subject that the user may be interested in. Therefore, the selected second content may also be utilized as marketing information.

In this exemplary embodiment, the providing unit 101 outputs, for example, one of the external-appearance images (i.e., the first contents) shown in FIG. 9 selected by the user as an image based on the selected option. In this case, the providing unit 101 provides the image service by providing the image based on the selected option. In addition, the providing unit 101 outputs, for example, one of the contents (i.e., the second contents) shown in FIG. 10 selected by the user as an image based on the selected option. In this case, the providing unit 101 outputs the image based on the selected option in addition to the image provided in the image service. In either case, when providing the image service, the providing unit 101 outputs the images based on the selected options.

In this exemplary embodiment, for example, a first content is output. The first content is information expressing a subject that the user is interested in because the first content is the purpose for which the user operates the image forming apparatus 10 to begin with. In addition, in this exemplary embodiment, a second content is output. For example, if a second content is not necessary, a second content does not have to be output. In that case, if a second content is still output, the output second content is information expressing a subject that the user may be interested in.

Accordingly, both kinds of contents tend to express subjects that the user is interested in more in detail as compared with non-contents, thus increasing the value thereof as marketing information. Therefore, according to this exemplary embodiment, high-value information may be acquired as marketing information as compared with a case where information other than the contents is acquired. Furthermore, in a case where the image forming apparatus 10 is installed in a service facility, such as a rest area of an expressway, as described in the first exemplary embodiment, the satisfaction level of the user further improves and the number of visitors visiting the service facility further increases, as compared with a case where information other than the contents is acquired, thus contributing to improved sales for the retail stores in the service facility.

### 3. Third Exemplary Embodiment

A third second exemplary embodiment of the present invention will be described below while focusing on the differences from the first and second exemplary embodiments. In the third exemplary embodiment, the shapes, colors, or sizes of images provided by the service are presented as options.

3.1. Functional Configuration

In this exemplary embodiment, the presenting unit 103 presents the shapes, colors, or sizes of images provided by the service as options. The images provided by the service are, for example, the aforementioned decorative output images and decorative display images, as well as the images included in the first and second contents.

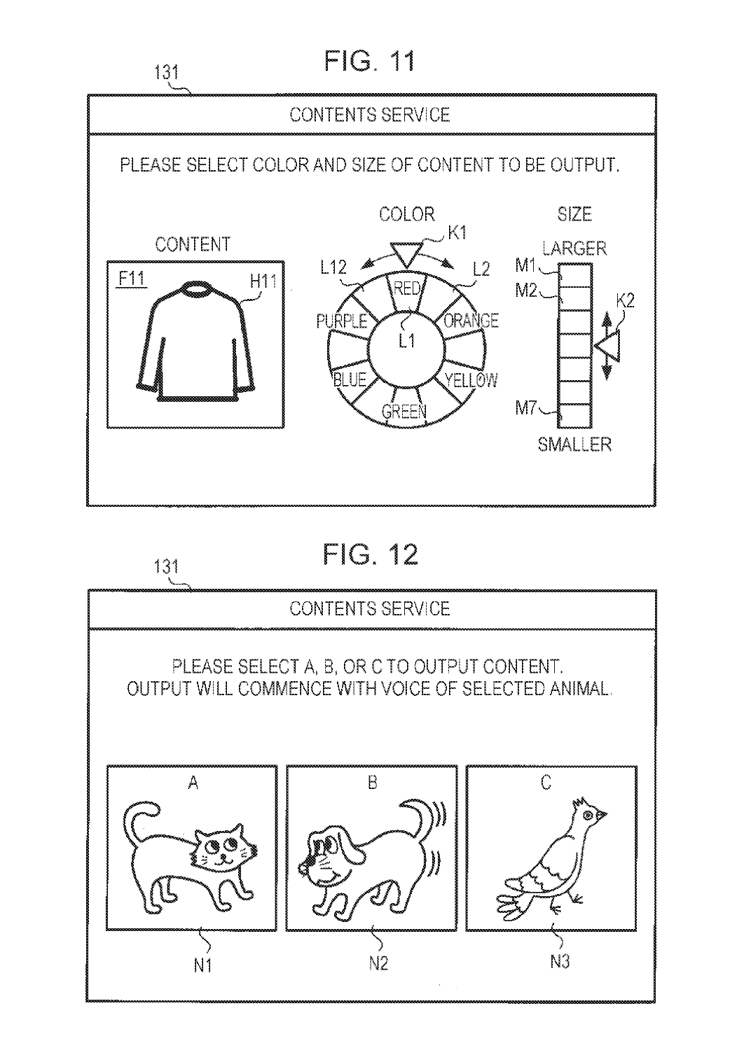

FIG. 11 illustrates an example of options presented to the user. In this example, the colors and the sizes of a clothing image H11 included in a content F11 provided in the contents service are displayed as options on the display screen 131. In detail, the display screen 131 displays images L1, L2, . . . , L12 (referred to as “color selection images” hereinafter) indicating options of twelve colors including red, orange, yellow, green, blue, and purple. Moreover, the display screen 131 displays images M1, M2, . . . , M7 (referred to as “size selection images” hereinafter) indicating options of seven levels of sizes. Furthermore, the display screen 131 also displays an image K1 designating the selected color selection image and an image K2 designating the selected size selection image. When the user moves the images K1 and K2 in directions indicated by arrows in FIG. 11, a color selection image and a size selection image are selected, respectively. The output unit 104 outputs the shape, the color, or the size of the image selected in an operation received by the receiving unit 102.

For example, the color selected by the user from the aforementioned options may be user's favored color or a color that expresses user's feelings at the time. It is also known that the color selected by the user may be used for analyzing user's personality or psychological state. In other words, the selected color selection image tends to express user's personality or psychological state as compared with the other color selection images. Furthermore, if the user has a strong interest in a particular content, the user may sometimes increase the size of the image thereof so as to allow for better viewability of the image. In other words, the selected size selection image tends to express the level of interest the user may have in that content as compared with the other size selection images. For example, the above description regarding colors similarly applies to shapes in a case where the presenting unit 103 presents the shapes of an image used as a decorative output image as options. In other words, the selected shape option tends to express user's personality or psychological state as compared with the other options.

Accordingly, the options output in this exemplary embodiment express elements, such as user's personality, psychological state, and level of interest, which may affect user's selection subconsciously. These elements may also affect user's demands. For example, a user who likes blue color has the tendency to select products carefully, whereas a user who likes red color has the tendency to buy products on impulse. According to this exemplary embodiment, information for ascertaining the tendencies of subconscious actions taken by users against users' desired items may be acquired as marketing information.

### 4. Modifications

The above-described exemplary embodiments are merely examples of exemplary embodiments of the present invention and may be modified as follows. Furthermore, the above-described exemplary embodiments and the following modifications may be combined where appropriate.

4.1. Operators Receiving Common Operation

The presenting unit 103 may present operators, which are used for receiving certain operations in the service, as options. In this case, the operators are multiple operators with different attributes.

FIG. 12 illustrates an example of operators presented as options. In this example, the display screen 131 displays operators N1, N2, and N3 each used for receiving an operation for commencing output of an image to a medium in the image service.

The operators N1, N2, and N3 express characters A, B, and C and cat, dog, and bird character images, respectively. Furthermore, the display screen 131 also displays a character string “Please select A, B, or C to output content. Output will commence with voice of selected animal.” The user viewing this display screen 131 may perform an operation for selecting one of the operators N1, N2, and N3 so as to output the selected content. The output unit 104 outputs the attribute of the selected operator when the receiving unit 102 receives a certain operation (i.e., the operation for commencing the output of the image to the medium in the example in FIG. 12).

In the example in FIG. 12, the user is likely to select an operator that expresses the animal that the user relatively likes or that expresses the character image of the animal whose voice the user relatively wants to hear, as compared with the other operators. In other words, these operators are options that are variably selected in accordance with user's attribute, and may be utilized as marketing information. Unless the user selects one of the operators, the output of the content to the medium does not commence. Specifically, this operation has to be performed in order to use the image service. Even if the operators N1, N2, and N3 were not presented, any other kind of operator is presented so as to make the user perform this operation. In other words, even if the options were not presented, the number of times the user performs the operation does not change. According to this modification, marketing information may be acquired without having to increase the number of operations for using the service.

4.2. Unselected Options

The output unit 104 may output the option selected by user's operation and also output the options not selected in that operation. For example, when the decorative output image C5 is selected from the options shown in FIG. 6, it is presumed that the user has an attribute in which the user likes cats more than dogs, birds, and reptiles if it is confirmed that the decorative output images C7, C8, and C9 are not selected. In contrast, in a case where the unselected options are not output, it may be difficult to determine what other animals are there to compare with what the user likes, that is, cats. With this modification, high-value information may be acquired as marketing information as compared with a case where unselected options are not output.

4.3. Information Processing Apparatus and Service Provided to User

The exemplary embodiments of the present invention are not limited to an image forming apparatus and may be applied to other kinds of information processing apparatuses. For example, the exemplary embodiments may be applied to an information processing apparatus, such as a kiosk terminal, which does not form an image but provides some kind of service to a user. Specifically, a kiosk terminal is, for example, an order-receiving terminal installed in a restaurant, etc., a tourist-site guide terminal installed in a tourist site, or a facility guide terminal installed in a station, a public facility, etc.

The service provided to the user is not limited to the image service described above. In a case where the aforementioned kiosk terminal is used as the information processing apparatus, a service, such as a product-order receiving service, a tourist-site guide service, or a facility guide service, may be provided to the user. Accordingly, any kind of service may be provided by the information processing apparatus so long as the service is of any help to the user. In other words, the information processing apparatus may be any kind of apparatus so long as it realizes the units shown in FIG. 2.

4.4. Presentation of Options

In each of the above exemplary embodiments, the presenting unit 103 presents options to the user by using images. Alternatively, the presenting unit 103 may present options by using, for example, sound. In this case, the presenting unit 103 outputs voices expressing the details of the options via the sound output section 18. Furthermore, the presenting unit 103 may be equipped with a unit that forms Braille characters indicating designated character strings so as to express the details of the options by using Braille characters.

Furthermore, the presenting unit 103 may present the options to the user via an external device. In this case, for example, a server apparatus connected to a network may be used as the information processing apparatus, and the server apparatus may present the options to the user via a client terminal connected to the server apparatus via the network. When the user selects an option, the client terminal notifies the server apparatus of the selection result, and the server apparatus outputs the notification result, that is, the selected option. Accordingly, the presenting method used by the presenting unit 103 may be of any kind so long as it presents the options to the user using the service.

4.5. Providing of Service Via External Device

The providing unit 101 may provide the service via an external device, such as a smartphone, carried by the user. For example, when the user selects a content from the usable images shown in FIG. 3 and subsequently performs an operation for changing the output destination of the content from a medium to the smartphone, the providing unit 101 transmits the selected content to the smartphone via a network, such as the Internet. In this case, the providing unit 101 may directly transmit the content or transmit information indicating the legal right to acquire the content. In the latter case, the smartphone downloads the content from, for example, a predetermined website by using the transmitted information indicating the legal right.

As another alternative, the providing unit 101 may output a sheet for requesting transmission of a content. In this case, the user may input a necessary item (such as user's mail address) to the sheet, and the image may be scanned or may be transmitted to a predetermined destination by facsimile. Then, the providing unit 101 may transmit the content to user's smartphone via, for example, electronic mail. In this case, an electronic mark, such as a quick response (QR) code or an augmented reality (AR) marker, may be output to the sheet, and the electronic mark may be read with the smartphone. Thus, the image forming apparatus 10 may be accessed by the smartphone, and the providing unit 101 may transmit the content in response thereto.

The providing unit 101 may perform the above-described output to the sheet at any time from the time point at which the operation performed by the user when using the service is received by the receiving unit 102 to the time point at which the providing of the service by the providing unit 101 ends. Furthermore, when the smartphone accesses the apparatus on the basis of the output sheet, the providing unit 101 may change the service to be provided on the basis of information related to the access (e.g., information of the content to be transmitted to the smartphone in accordance with the access). For example, in a case where a copy service is provided, a reduced version of the content to be transmitted to the smartphone in accordance with the aforementioned access may be output to the reverse face of the output sheet. As described above, information to be provided to the external device may be a decorative output image described in the first exemplary embodiment or a first or second content described in the second exemplary embodiment.

4.6. Categories of Exemplary Embodiments

In addition to the information processing apparatus such as the image forming apparatus 10, the exemplary embodiments of the present invention may each be considered as an information processing method for realizing the process performed by the information processing apparatus. The term “process” in this case is, for example, the acquisition process shown in FIG. 8. Furthermore, the exemplary embodiments of the present invention may each be considered as a program for causing a computer, such as a communication terminal or an information processing apparatus, to function as the units shown in FIG. 2. This program may be provided in the form of a storage medium storing the program, such as an optical disk, or may be made usable by being downloaded onto a computer via a network, such as the Internet, and installed in the computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a providing unit that provides a service to a user;
a receiving unit that receives an operation performed by the user when using the service provided by the providing unit;
a presenting unit that presents options to the user using the service; and
an output unit that outputs an option selected in the operation for selecting the option from among the options presented by the presenting unit when the receiving unit receives the operation, the option being variably selected in accordance with an attribute of the user,
wherein when the providing unit provides the service, the providing unit outputs an image based on the option selected in the operation.

2. The information processing apparatus according to claim 1,
wherein the presenting unit presents details of decoration performable in the service as the options.

3. The information processing apparatus according to claim 1,
wherein the presenting unit presents details of contents provided by the service as the options.

4. The information processing apparatus according to claim 1,
wherein the presenting unit presents shapes, colors, or sizes of images provided by the service as the options.

5. The information processing apparatus according to claim 1,
wherein the presenting unit presents a plurality of operators that are each used for receiving a certain operation in the service and that have different attributes, and
wherein the output unit outputs the attribute of a selected one of the operators when the certain operation is received by the receiving unit.

6. The information processing apparatus according to claim 1,
wherein the output unit outputs the option selected in the operation and also outputs an option not selected in the operation.

7. A non-transitory computer readable medium storing a program causing a computer to execute a process for processing information, the process comprising:
providing a service to a user;
receiving an operation performed by the user when using the provided service;
presenting options to the user using the service;
outputting an option selected in the operation for selecting the option from among the presented options when the operation is received, the option being variably selected in accordance with an attribute of the user; and
providing the service by outputting an image based on the option selected in the operation.

8. An information processing method comprising:
providing a service to a user;
receiving an operation performed by the user when using the provided service;
presenting options to the user using the service;
outputting an option selected in the operation for selecting the option from among the presented options when the operation is received, the option being variably selected in accordance with an attribute of the user; and
providing the service by outputting an image based on the option selected in the operation.
